(19) United States
(12) Patent Application Publication
(10) Pub. No.: US 2007/0067594 A1
(43) Pub. Date: Mar. 22, 2007

(54) Method and apparatus to perform clock crossing on data paths

(76) Inventor: Mamun U. Rashid, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/230,423

(22) Filed: Sep. 19, 2005

(51) Int. Cl. G06F 13/00

(52) U.S. Cl. 711/167

(57) ABSTRACT

A method and an apparatus to perform clock crossing on data paths have been disclosed. In one embodiment, the method includes sampling data received by a first memory device in a computing system on a first data path to determine a clock crossing phase, the data on the first data path being in a first domain of a receive clock signal. The method may further include modifying a transmit clock signal based on the clock crossing phase. In some embodiments, the method further includes transferring data received by the first memory device on a plurality of data paths from the first domain of the receive clock signal into a second domain of the modified transmit clock signal. Other embodiments have been claimed and described.

### TECHNICAL FIELD

Embodiments of the invention relate generally to semiconductor circuits, and more particularly, to clock crossing on data paths.

### BACKGROUND

To meet the high-speed demand of advance processors in some computing systems, repeater dynamic random access memories (repeater DRAM) are used to create multi-rank systems in a point-to-point link scheme. FIG. 1A shows an exemplary repeater DRAM 100 and FIG. 1B shows the internal repeat data paths 101-104 of the exemplary repeater DRAM 100. In addition to transmitting core data to or from the DRAM array 110, the repeater DRAM 100 may repeat or retransmit high-speed Command Address/ Write Data (CA/WrData) and/or high-speed Read Data (RdData) from one side to another side of the repeater DRAM. For instance, CA/WrData and RdData may be repeated from primary side 102 to secondary side 103, or vice-versa. Referring to FIG. 1B, the 6-bit CA/WrData is repeated from the primary side 102 (also referred to as the host side) to the secondary side 103 in order to transmit CA/WrData to another repeater DRAM coupled to the secondary side of the repeater DRAM 100 shown. Likewise, an 8-bit RdData is repeated from the secondary side 103 to the primary side 102 of the repeater DRAM 100.

In some cases, the high-speed data on the data paths 101-104 is captured by a source synchronous receive clock signal (RxClk), and then transferred to the domain of an internal transmit clock (TxClk) of the repeater DRAM using the clock crossing blocks 121-124, respectively. Then the transferred data is sent out through the output ports using TxClk. The transfer of data one clock domain to another clock domain is commonly referred to as clock crossing.

In some computing systems, the point-to-point link is a source synchronous link, i.e., one clock is forwarded along with every group of data signals. The repeater DRAMs in these computing systems may adopt quarter rate clocking to accommodate the high data rate in slow DRAM process, where the clock rate is one-fourth (¼) of the data rate. Then data received by these repeater DRAMs may be captured using four phases of a receive clock signal.

FIG. 2A illustrates a conventional high-speed repeat data path 200 in an exemplary repeater DRAM adopting quarter rate clocking. Note that only one data input is shown in FIG. 2A to simplify the illustration. The incoming serial data 201 is fanned out to four interconnects and captured by four sampling flip-flops 211-214 using four phases of RxClk (RxClk0, RxClk90, RxClk180, and RxClk270). The data received is valid for four unit interval (UI) time at the output of the sampling flip-flops 211-214. The received data has to be transferred from RxClk domain to TxClk domain and be sent out through the output buffer with little latency. Note that RxClk and TxClk may operate at substantially the same frequency, but have an arbitrary phase relation between them. TxClk could be anywhere between 0° and 360° phase of RxClk. Also there may be long routing (100's to 1000's of um) or physical separation between the receive and transmit ports, and as a result, one to two UI of routing delay may be introduced.

Referring back to FIG. 2A, the data on each interconnect is transferred from RxClk domain to TxClk domain by one of the of the clock crossing blocks 221-224. Since there are four phases of TxClk, four flip-flops are used in each of the clock crossing blocks 221-224 to sample data. Each of the four flip-flops is clocked by one of the four phases of TxClk. for example, clock crossing block 221 includes flip-flops 231-234, where flip-flop 231 is clocked by Tx0°, flip-flop 232 is clocked by Tx90°, flip-flop 233 is clocked by Tx180°, and flip-flop 234 is clocked by Tx270°. As illustrated in FIG. 2A, a total of sixteen flip-flops are used on the data path 200 to transfer the received data from RxClk domain to TxClk domain. FIG. 2B shows some exemplary received data (e.g., Rx-B[0]) being transferred to TxClk domain by a conventional clock crossing block.

### BRIEF DESCRIPTION OF THE DRAWINGS

Embodiments of the present invention is illustrated by way of example and not limitation in the figures of the accompanying drawings, in which like references indicate similar elements and in which:

FIG. 1A shows an exemplary repeater DRAM;

FIG. 1B shows the internal data path of the exemplary repeater DRAM;

FIG. 2A shows a conventional high-speed repeat data path;

FIG. 2B shows exemplary received data being sampled by four phases of TxClk in a conventional clock crossing block;

FIG. 3A illustrates one embodiment of a circuit to determine a clock crossing phase;

FIG. 3B illustrates one embodiment of a data path with an adaptive clock domain crossing scheme;

FIG. 4 illustrates one embodiment of a process to perform clock crossing;

FIG. 5 illustrates an exemplary embodiment of a computing system; and

FIG. 6 illustrates an alternative embodiment of the computing system.

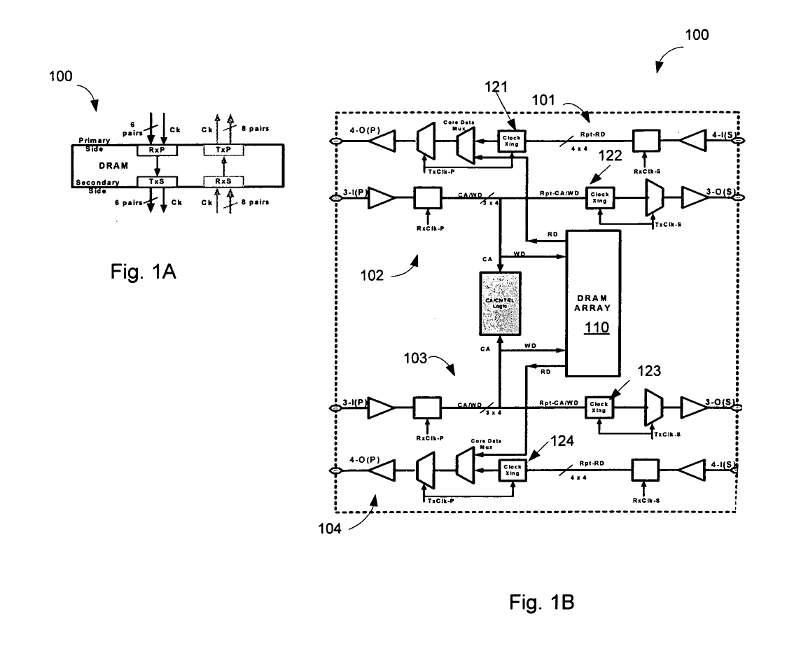

### DETAILED DESCRIPTION

A method and an apparatus to perform clock crossing on data paths are disclosed. In the following detailed description, numerous specific details are set forth in order to provide a thorough understanding. However, it will be apparent to one of ordinary skill in the art that these specific details need not be used to practice some embodiments of the present invention. In other circumstances, well-known structures, materials, circuits, processes, and interfaces have not been shown or described in detail in order not to unnecessarily obscure the description.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

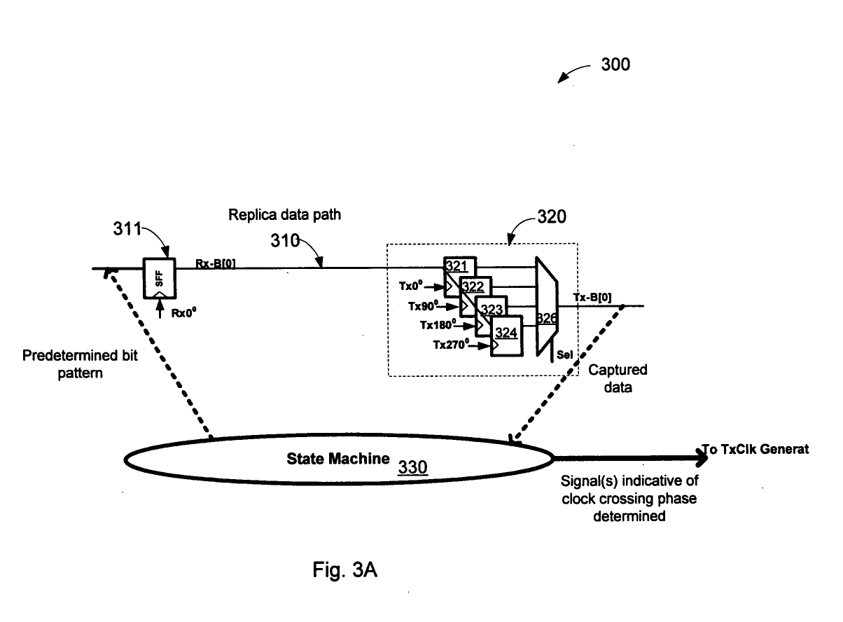

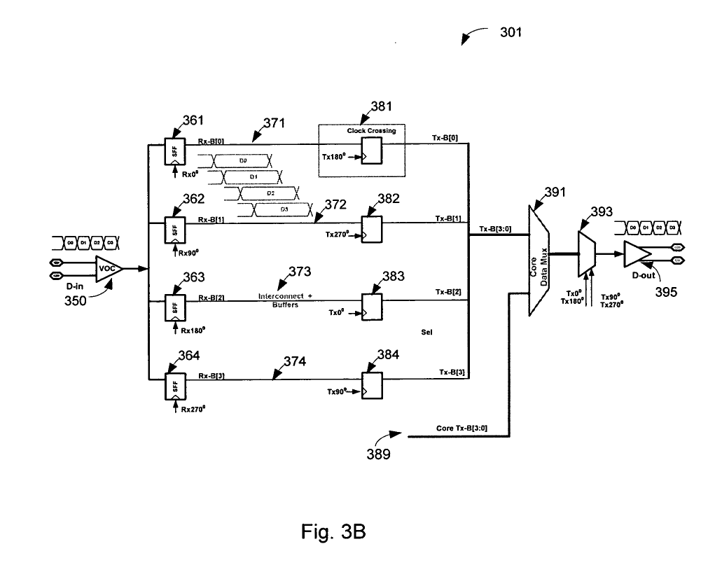

FIG. 3A shows one embodiment of a circuit to determine a clock crossing phase in a memory device. The circuit 300 includes a replica data path 310, a flip-flop 311, a sampling circuit 320, and a logic device 330. The logic device 330 may include one or more state machines. In some embodiments, the replica data path 310 is coupled to the flip-flop 311 clocked by a receive clock signal (RxClk) on one end. On the other end of the replica data path 310, the replica data path 310 may be coupled to inputs of the sampling circuit 320. The output of the sampling circuit 320 is coupled to the logic device 330. The logic device 330 may be coupled to the input of the flip-flop 311. Note that the circuit 300 may include more or less components than those shown in FIG. 3A in different embodiments. Details of some exemplary operations of the circuit 300 are discussed below.

In one embodiment, the logic device 330 outputs data in a predetermined bit pattern (e.g., 110001100011 . . . , 101010. . . , etc.) to the flip-flop 311. The flip-flop 311 is clocked by a receive clock signal (RxClk). The flip-flop 311 may send the data carried by RxClk over the replica data path 310 to the sampling circuit 320. In some embodiments, the replica data path 310 is 1-bit wide. The sampling circuit 320 captures the data using a plurality of phases of a transmit clock signal (TxClk) which may be generated by an internal transmit clock generator of the memory device. For example, the sampling circuit 320 may capture the data received using four phases of TxClk, such as 0° (Tx0°), 90° (Tx90°), 180° (Tx180°), and 270° (Tx270°), when the memory device adopts quarter rate clocking. In one embodiment, the sampling circuit 320 includes four flip-flops 321-324 to capture the data, where each one of the flip-flops 321-324 is clocked by a distinct one of the four phases of TxClk. The sampling circuit 320 may further include a multiplexer (MUX) 326 coupled to the flip-flops 321-324 to select one of the outputs of the flip-flops 321-324 to input to the logic device 330. Note that TxClk and RxClk may have substantially identical frequency in some systems.

The logic device 330 may evaluate the captured data from the sampling circuit 320 to determine a clock crossing phase. In one embodiment, the logic device 330 selects the TxClk phase that gives a margin of one UI for both hold and setup direction as the clock crossing phase to accommodate clock drift and jitter. Referring back to the above example, where four TxClk phases are used to capture the data, the data can be captured by at least three of the four TxClk phases. The logic device 330 may compare the data captured by the at least three phases. Then the logic device 330 may select the phase in the middle among the at least three phases to be the clock crossing phase, thus, leaving at least a margin of one UI in both setup and hold direction. Once the clock crossing phase is determined, the logic device 330 may send one or more signals indicating the clock crossing phase to the transmit clock generator. The transmit clock generator may modify TxClk based on the clock crossing phase. For instance, the transmit clock generator may assign the clock crossing phase to be the new 180° phase of TxClk. The modified TxClk can be used in clock crossing on data received on other data paths in the memory device.

FIG. 3B illustrates one embodiment of a data path 301 in a memory device with an adaptive clock domain crossing scheme. Note that only one data input is shown in FIG. 3B to simplify the illustration. One of ordinary skill in the art would readily recognize from the illustration and the description herein that the technique disclosed can be applied to data paths having multiple data inputs. Referring to FIG. 3B, an input buffer 350, four interconnects 371-374, four flip-flops 361-364, four clock crossing units 381-384, a core data MUX 391, a second MUX 393, and an output buffer 395 are shown. The input buffer 350 is coupled to the four flip-flops 361-364. Each of the four flip-flops 361-364 is coupled via one of the interconnects 371-374 to one of the clock crossing units 381-384. The outputs of the clock crossing units 381-384 are coupled to the core data MUX 391, which is further coupled to the second MUX 393. The output of the second MUX 393 is coupled to the output buffer 395. Note that other embodiments may include more or less components than those shown in FIG. 3B.

In some embodiments, data is serially input to the input buffer 350 and then fanned out to the four flip-flops 361-364. Each of the four flip-flops 361-364 may be clocked by one of four phases of a receive clock signal (RxClk), such as 0° (Rx0°), 90° (Rx90°), 180° (Rx180°), and 270° (Rx270°). The output of each of the four flip-flops 361-364 is coupled to one of the interconnects 371-374 at one end. At the other end, each of the interconnects 371-374 is coupled to one of the clock crossing units 381-384. Each of the clock crossing units 381-384 may be implemented with a single flip-flop clocked by one of the phases of a transmit clock signal (TxClk) to transfer the incoming data from the corresponding interconnect from RxClk domain to TxClk domain. In some embodiments, the 180° phase of TxClk is changed to the clock crossing phase determined using a replica data path, a sampling circuit, and a logic device. Details of some embodiments of the scheme to determine the clock crossing phase have been described in details with reference to FIG. 3A.

After clock crossing, the data may be sent out of the memory device. In one embodiment, the outputs of the clock crossing units 381-384 are input to the core data MUX 391. In addition, the core data MUX 391 may receive core data 389 from a memory array (not shown) of the memory device. The core data MUX 391 selects data from one of the clock crossing blocks 381-384 and the core data. The selected data is input to the second MUX 393. The second MUX 393 receives TxClk at different phases (e.g., Tx0°, Tx90°, Tx180°, and Tx270°) from an internal transmit clock generator of the memory device. In response to the different phases of TxClk, the second MUX 393 selects an output from core data MUX 391 to input to the output buffer 395, through which the selected output is sent out of the memory device.

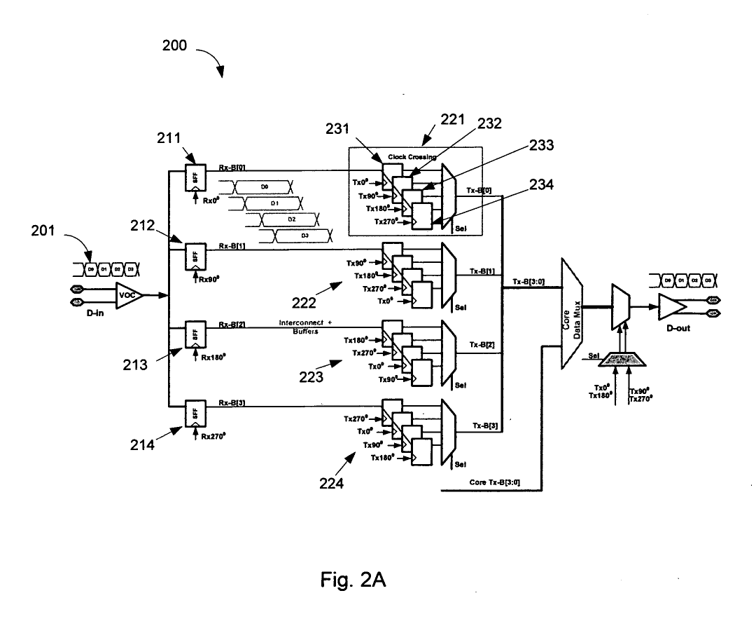

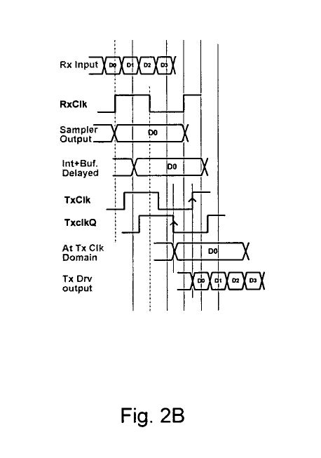

The clock crossing technique discussed above greatly simplifies data paths in memory devices, especially for high-speed repeat data paths. Since only one TxClk phase is used to transfer data from RxClk domain to TxClk domain, each of the clock crossing units 381-384 can be implemented by a single flip-flop instead of four flip-flops (as shown in FIG. 2A). Furthermore, by using fewer clock loading and multiplexers in the data path, both power usage and latency are reduced. Moreover, since the clock crossing phase is determined by sampling data on the replica data path within the memory device, such determination is independent of process, voltage, and/or temperature variations. Note that the above clock crossing technique is applicable to a wide range of data paths, such as high-speed memory interfaces (e.g., high-speed repeater memory, high-speed DRAM, etc.), high-speed to low speed interfaces (e.g., as in core data paths), etc.

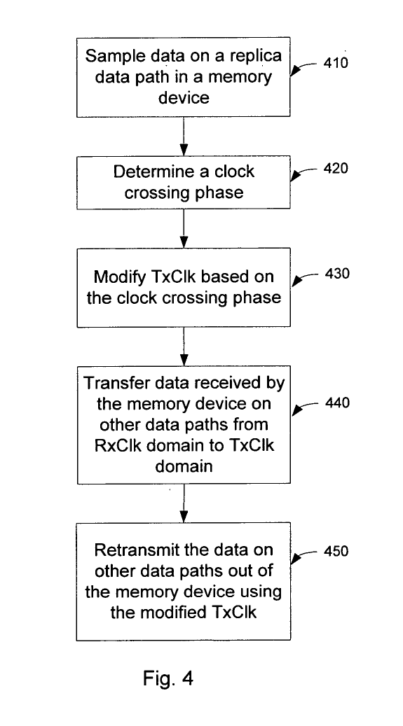

FIG. 4 shows one embodiment of a process to perform clock crossing on data paths in a memory device in a computing system. The process is performed by processing logic that may comprise hardware (e.g., circuitry, dedicated logic, etc.), software (such as a program operable to run on a general-purpose computer system or a dedicated machine), or a combination of both.

In one embodiment, processing logic samples data carried by a receive clock signal (RxClk) on a replica data path in the memory device (processing block 410). The sampling may be done during initialization of the memory device in the computing system. To sample the data, processing logic may capture the data using a number of different phases of a transmit clock signal (TxClk). Then processing logic evaluates the captured data to determine the clock crossing phase (processing block 420). For example, processing logic may select one of the different phases of TxClk to be the clock crossing phase. In one embodiment, processing logic selects the phase in the middle among a number of phases that capture the data validly to allow for clock drift and jitter.

Based on the clock crossing phase, processing logic may modify TxClk (processing block 430). In one embodiment, processing logic changes the 180° phase of TxClk to be the clock crossing phase determined in processing block 420. In one embodiment, processing logic uses a logic device and a transmit clock generator to modify TxClk. Processing logic may modify TxClk in a variety of ways, such as current phase inversion, phase shifting phase interpolator (PI) code. Then processing logic transfers data received by the memory device on other data paths from the RxClk domain into the modified TxClk domain (processing block 440). Finally, the data on other data paths are retransmitted out of the memory device using TxClk (processing block 450).

In some embodiments, processing logic continuously sample data on the replica data path to monitor the data on the replica data path. If the sampled data changes, processing logic may modify the clock crossing phase accordingly. Alternatively, processing logic may periodically sample data on the replica data path. Such continuous or periodical sampling of data on the replica data path allows the memory device to readjust the clock crossing phase from time to time, and hence, data can be adaptively transferred from RxClk domain to TxClk domain.

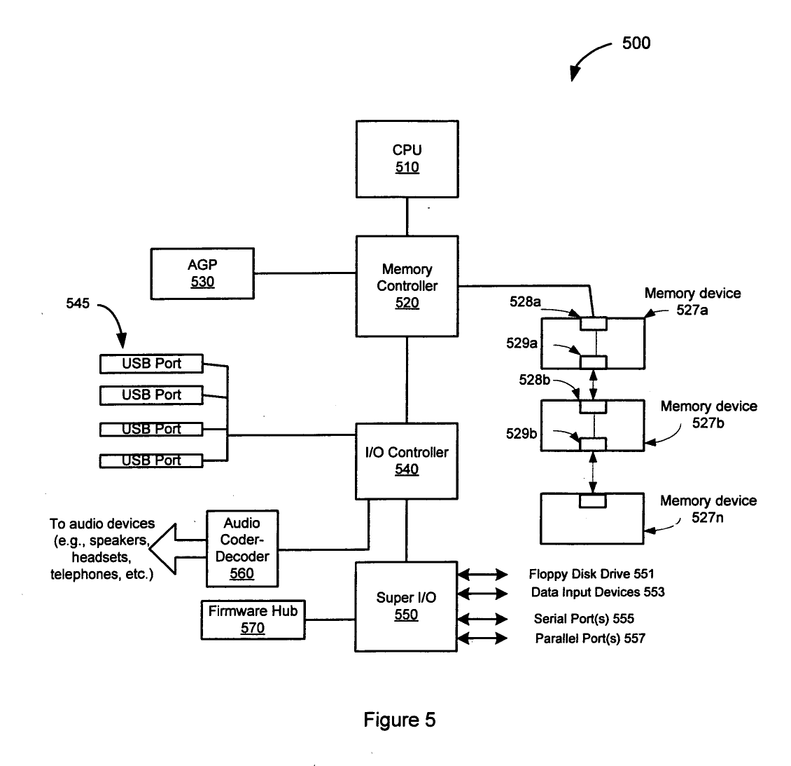

FIG. 5 shows an exemplary embodiment of a computer system 500 usable with some embodiments of the invention. The computer system 500 includes a central processing unit (CPU) 510, a memory controller 520, a number of memory devices 527a-527n, a graphic port (AGP) 530, an input/output (I/O) controller 540, a number of network interfaces (such as Universal Serial Bus (USB) ports 545, Super Input/Output (Super I/O) 550, etc.), an audio coder-decoder 560, and a firmware hub (FWH) 570.

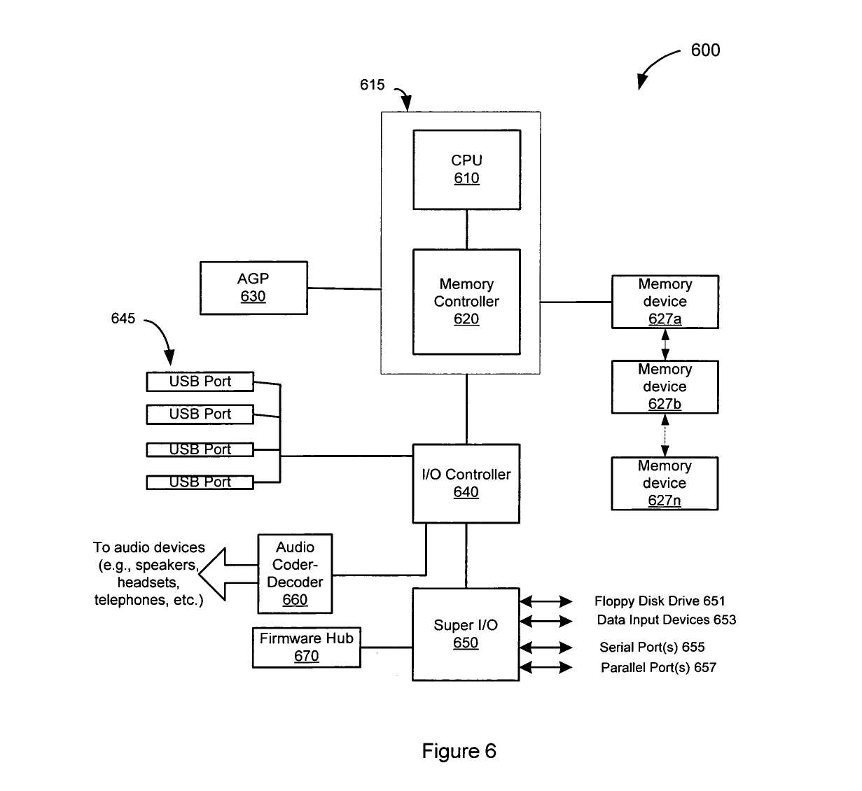

In one embodiment, the CPU 510, the graphic port 530, the memory device 527, and the I/O controller 540 are coupled to the memory controller 520. The memory controller 520 interfaces with the memory device 527a and routes data to and from the memory device 527a. The data may be routed between the memory controller 520 and the memory devices 527b-527n via the memory device 527a. In some embodiments, the memory controller 520 resides on different integrated circuit substrate from the CPU 510. The memory controller 520 may be referred to as a memory controller hub. However, in an alternative embodiment illustrated in FIG. 6, the memory controller 620 resides on the same integrated circuit substrate 615 with the CPU 610, while the rest of the system 600 may be substantially similar to the system 500 in FIG. 5.

The chip with the CPU 510 may include only one processor core or multiple processor cores. In some embodiments, the same memory controller 520 may work for all processor cores in the chip. Alternatively, the memory controller 520 may include different portions that may work separately with different processor cores in the chip.

The memory devices 527a-527n may include various types of memories, such as, for example, dynamic random access memory (DRAM), synchronous dynamic random access memory (SDRAM), double data rate (DDR) SDRAM, repeater DRAM, etc. In one embodiment, the USB ports 545, the audio coder-decoder 560, and the Super I/O 550 are coupled to the I/O controller 540. The Super I/O 550 may be further coupled to a firmware hub 570, a floppy disk drive 551, data input devices 553 (e.g., a keyboard, a mouse, etc.), a number of serial ports 555, and a number of parallel ports 557. The audio coder-decoder 560 may be coupled to various audio devices, such as speakers, headsets, telephones, etc.

Each of the memory devices 527a-527n includes one or more input/output (I/O) interfaces, such as I/O interfaces 528a, 529a, 528b, 529b, etc. depicted in FIG. 5. Each of the I/O interfaces may include a replica data path, a sampling circuit, a logic device, and a transmit clock generator to determine a clock crossing phase for clock crossing on data paths.

In some embodiments, data on the replica data path is sampled by the sampling circuit to determine the clock crossing phase. The data on the replica data path being in a domain of a receive clock signal (RxClk). Then a transmit clock signal (TxClk) is modified based on the clock crossing phase. During operation of the memory device, data received by the memory device on the data paths in the memory device is transferred from the RxClk domain into the TxClk domain. More details of various embodiments of the processes to perform clock crossing on data path have been described in details above.

Note that any or all of the components and the associated hardware illustrated in FIG. 5 may be used in various embodiments of the computer system 500. However, it should be appreciated that other configurations of the computer system may include one or more additional devices not shown in FIG. 5. Furthermore, one should appreciate that the technique disclosed above is applicable to different types of system environment, such as a multi-drop environment or a point-to-point environment. Likewise, the disclosed technique is applicable to both mobile and desktop computing systems.

Some portions of the preceding detailed description have been presented in terms of symbolic representations of operations on data bits within a computer memory. These descriptions and representations are the tools used by those skilled in the data processing arts to most effectively convey the substance of their work to others skilled in the art. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations described herein. This apparatus may be specially constructed for the required purposes, or it may comprise a general-purpose computer selectively activated or reconfigured by a computer program stored in the computer. Such a computer program may be stored in a machine-accessible storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will appear from the description below. In addition, embodiments of the present invention are not described with reference to any particular programming language. It will be appreciated that a variety of programming languages may be used to implement the teachings as described herein.

The foregoing discussion merely describes some exemplary embodiments of the present invention. One skilled in the art will readily recognize from such discussion, the accompanying drawings and the claims that various modifications can be made without departing from the spirit and scope of the subject matter.

What is claimed is:

1. A method comprising:
sampling data received by a first memory device in a computing system on a first data path to determine a clock crossing phase, the data on the first data path being in a first domain of a receive clock signal;
modifying a transmit clock signal based on the clock crossing phase; and
transferring data received by the first memory device on a plurality of data paths from the first domain of the receive clock signal into a second domain of the modified transmit clock signal.

2. The method of claim 1, wherein sampling the data received by the first memory device comprises:
capturing the data on the first data path using a plurality of phases of the transmit clock signal.

3. The method of claim 2, further comprising:
evaluating the captured data to select the clock crossing phase out of the plurality of phases of the transmit clock signal.

4. The method of claim 1, further comprising:
sending the data on the plurality of data paths from the first memory device to a second memory device using the modified transmit clock signal.

5. An apparatus comprising:
a sampling circuit coupled to a first data path to sample the data on the first data path using a plurality of phases of a transmit clock signal, the data on the first data path being in a first domain of a receive clock signal;
a logic device coupled to the sampling circuit to determine a clock crossing phase based on the sampled data; and
a transmit clock generator coupled to the logic device to modify the transmit clock signal based on the clock crossing phase.

6. The apparatus of claim 5, wherein the logic device is further coupled to the first data path to send a predetermined bit pattern onto the first data path.

7. The apparatus of claim 5, further comprising:
a plurality of data paths to receive data; and
a plurality of clock crossing units coupled to each of the plurality of data paths to transfer the data on a corresponding one of the plurality of data paths from the first domain of the receive clock signal into a second domain of the modified transmit clock signal, the plurality of clock crossing units being further coupled to the transmit clock generator to receive the modified transmit clock signal.

8. The apparatus of claim 7, wherein the sampling circuit comprises:
a plurality of flip-flops, each of the plurality of flip-flops to receive the transmit clock signal at a distinct one of the plurality of phases.

9. The apparatus of claim 7, wherein each of the plurality of clock crossing units comprises a single flip-flop.

10. The apparatus of claim 5, wherein the logic device includes one or more state machines.

11. A system comprising:
a graphics chip;
a memory controller coupled to the graphics chip;
a first memory device coupled to the memory controller;
a second memory device having an interface to couple to the first memory device, the interface comprising:
a sampling circuit coupled to a first data path to sample the data on the first data path using a plurality of phases of a transmit clock signal, the data on the first data path being in a first domain of a receive clock signal;
a logic device coupled to the sampling circuit to determine a clock crossing phase based on the sampled data; and
a transmit clock generator coupled to the logic device to modify the transmit clock signal based on the clock crossing phase.

12. The system of claim 11, wherein the second memory device further comprises:
a plurality of data paths to receive data from the first memory device; and
a plurality of clock crossing units coupled to each of the plurality of data paths to transfer the data on a corresponding one of the plurality of data paths from the first domain of the receive clock signal into a second domain of the modified transmit clock signal, the plurality of clock crossing units being further coupled to the transmit clock generator to receive the modified transmit clock signal.

13. The system of claim 12, wherein the sampling circuit comprises:
a plurality of flip-flops, each of the plurality of flip-flops to receive the transmit clock signal at a distinct one of the plurality of phases.

14. The system of claim 12, wherein each of the plurality of clock crossing units comprises a single flip-flop.

15. The system of claim 11, wherein the second memory device comprises a repeater dynamic random access memory (DRAM).

16. The system of claim 11, further comprising a processor coupled to the memory controller.

17. The system of claim 16, wherein the processor and the memory controller reside on an integrated circuit substrate.

18. The system of claim 16, wherein the processor and the memory controller reside on different integrated circuit substrates.
